(19) United States
(12) Patent Application Publication
(10) Pub. No.: US 2006/0205439 A1
(43) Pub. Date: Sep. 14, 2006

(54) System and method for background sound scan element of a user interface

(75) Inventor: Kai Havukainen, Lempaala (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/075,783

(22) Filed: Mar. 9, 2005

(51) Int. Cl. H04B 1/38; G08B 5/22; G08B 25/08

(52) U.S. Cl. 455/567; 340/7.62; 340/692

(57) ABSTRACT

A method and system for playing a sound on an electronic device. An audio user interface control unit is used to manage various sounds that a user desires to be played upon the occurrence of a user interface-related action, as well as the rules regarding when and how such sounds are to be played. Virtually any sound can be played by the electronic device, and the sounds can be preinstalled on the device or downloaded from a remote location. Upon an occurrence of a designated user interface-related activity, the respective sounds are played according to the user-defined rules.

### FIELD OF THE INVENTION

The present invention relates generally to the field of electronic devices such as mobile telephones, personal digital assistants and computers. More particularly, the present invention relates to the personalization of user interfaces on electronic devices using various sounds.

### BACKGROUND OF THE INVENTION

Electronic devices, such as computers, cellular telephones, personal digital assistants, hand-held computers, positioning devices, and other devices have become increasingly versatile in recent years. As the capability and performance of these devices has increased, users have become increasingly able to customize settings on their own devices in a variety of ways. For example, for a number of years mobile telephone users have been able to choose their own ring tones, either by selecting a ring tone from a list that is stored in the device's memory or by downloading a ring tone from a network.

Traditionally, users have downloaded ring tones from a network by sending a short messaging services (SMS) message to a server within the network, indicating that the user desires to obtain the ring tone. The server would respond with a particular SMS message that includes machine-readable instructions which are used by the mobile telephone to reproduce the desired tone.

More recently, a number of other methods have been developed for providing customized audio content, such as music files, to users. Such processes are discussed, for example, in European Patent No. 1,210,709 and PCT Application Publication No. WO/0116931, both of which are incorporated herein by reference. These references describe methods for downloading audio characteristics to terminal equipment. A score information part describes presentation instructions of an audible signal. An instrument information part describes the parameters for synthesizing an audible signal, the presentation instructions of which are described by the score information part. In response to a selection command, the score information part and the instrument information part are downloaded to the terminal equipment through a communication network.

Although there have been prior improvements in how audio content can be downloaded and used on electronic devices, traditionally little attention has been paid to the issue of how the delivered UI audio content is utilized in mobile devices such as mobile telephones. In the past, user interfaces for various operating systems (OS) have offered the ability to map sound samples, or to used fixed samples, to certain UI events. For example and previously, sounds could be mapped to the pressing of a key on some mobile telephones, the start-up for mobile telephones and some operating systems, the initiation of a ‘critical stop’, the receipt of a “new mail notification” in some systems, and the initiation of a “receive call” action in a meeting application. Operating systems may also allow the mapping of sounds for some installed applications and their respective events. These types of sounds are referred to herein as “foreground” sounds.

Currently, systems exist for defining rule-based instructions for adequately mapping sounds to a user interface, but these systems are typically not designed for mobile telephones and similar devices. For example, a currently unfinished Interactive eXtensible Music Format (IXMF) standardization activity, which can be found at http://www.iasig.org/wg/ixw/ixwg.shtml, is primarily targeted for games. IXMF utilizes ‘cues’ that a game engine can call without actually knowing what sound it will trigger. A sound designer can define rules and sound resources for the cues. This enables, for example, the use of playlists.

For Internet web pages, Hyper-Text Markup Language (HTML) allows the triggering of a single MIDI or audio file when opening a web page. The file can also be looped. In another solution for web pages, the aural style sheet definition of Cascading Style Sheets level 2 (CSS2) (discussed at http://www.w3.org/TRIREC-CSS2/aural.html) allows the playback of a sample that is mixed with synthesized speech that reads the web pages. VoiceXML (discussed at http://www.w3.org/TR/voicexm120) also concentrate on speech synthesis and provides some sound mapping abilities for web pages. However, none of these systems provide a thorough and complete system for adequately mapping UI sounds and sound files, particularly on computers and mobile electronic devices such as mobile telephones and personal digital assistants. Furthermore, these earlier systems did not aid users in “eyes busy” situations and did not provide the user with the ability to significantly customize sounds on these respective devices.

### SUMMARY OF THE INVENTION

The present invention permits the use of sounds, such as background music, for personalization of a user interface for an electronic device, such as a mobile telephone, a personal digital assistant or a computer. Under the present invention, individual program applications do not control the sounds. Instead, the user interface of the device maintains the control. The sounds, and the rules for playing the sounds, can be downloadable. The playback rules may contain options such as playback order, random playback etc., and the user can also disable the entire feature if so desired.

With the present invention, a user is provided with the ability to customize his or her own device user interface in many more ways than have been previously possible. Sounds such as background music can also be utilized in recognizing an application or state, such as a menu, control panel or virtual screen selector, that is being used, which can be particularly helpful in an eyes-busy environment, for example. This can be particularly beneficial to those with impaired vision. The solution of the present invention also offers more variability than just triggering a certain sound sample, as is the case with many prior art systems. The present invention therefore provides a number of advantages to users of mobile devices that were not previously available.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a representation showing the modules and data flow that are used in a playback implementation according to one embodiment of the present invention; and

FIG. 5 is a flow chart showing the steps involved in the implementation of the present invention according to one embodiment thereof.

### DETAILED DESCRIPTION OF THE INVENTION

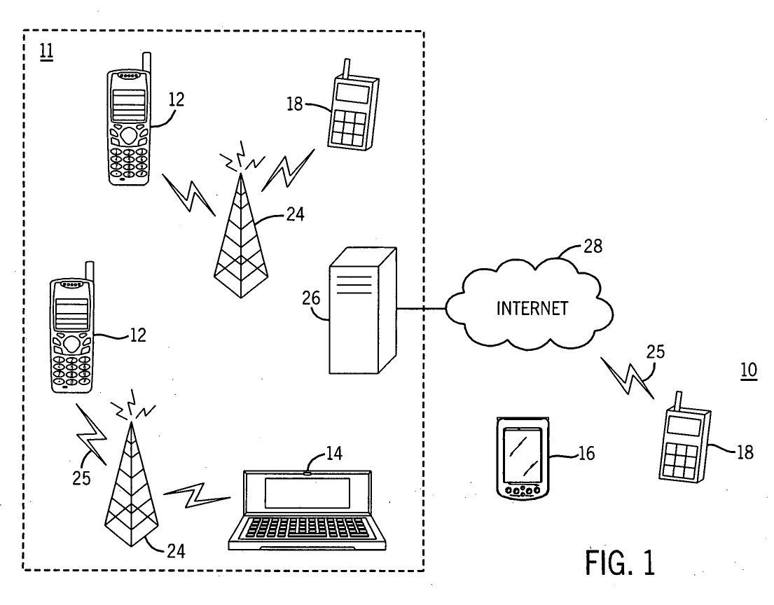

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, and an integrated messaging device (IMD) 18. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

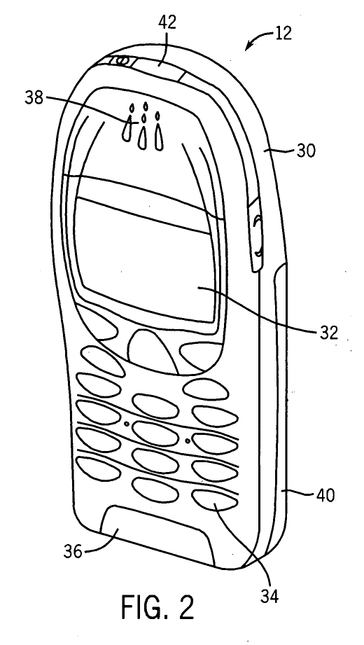

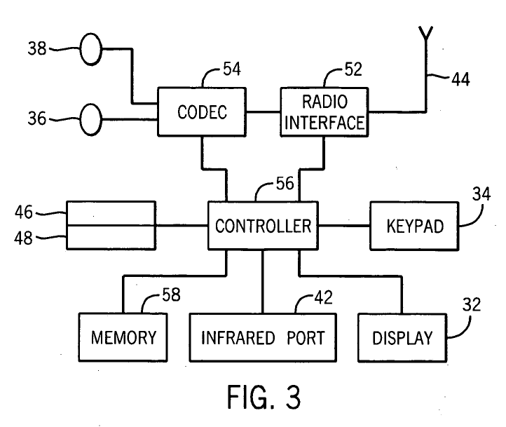

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention enables a rule-based functionality in a mobile device that can be used to play sounds such as background music when performing a variety of tasks. These tasks include, but are not limited to, browsing phone menus or other menus, as well as entering and exiting a screensaver application. It is also possible to determine background music for a particular application. With such background music, a user would be able to quickly and easily determine when a particular application is running. This can be particularly important in “eyes busy” situations where the user may otherwise have difficulty determining whether the application is open. The same background music can also play when a user is browsing through a menu and the particular application is highlighted, selected, or pointed at. Alternatively, a sample of the music can be played for the application when these actions are undertaken by the user. Different applications and actions may also have a low priority application running while background music associated with another running higher priority application is played. In the case of a song, the name of the song can be displayed whenever the song is being played by the system. The various sounds and the rules for the sounds' playback, such as selecting a playback order, controlling cross-fades between songs, randomizing sounds, etc., can be downloadable from the Internet or other wide area or local area network. The sounds can be in the form of music, sounds from nature (such as streaming water), animal sounds (such as birds singing), or virtually any other type of sound. Instead of sounds, particular lighting or highlighting can also be exhibited on the screen. All of these features are collectively referred to herein as “ambience.” Furthermore, this system can be enabled or disabled by the user at will in one embodiment of the present invention.

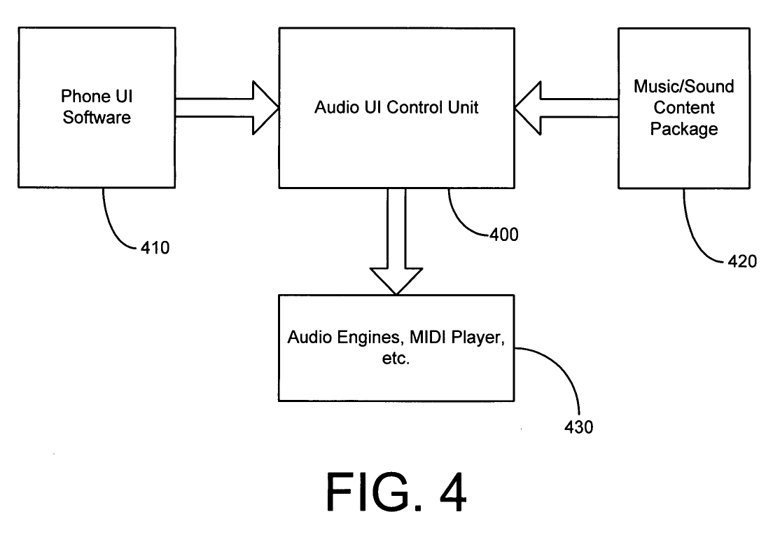

FIG. 4 is a representation of the elements involved in one implementation of the present invention. As shown in FIG. 4, an audio user interface control unit 400 is capable of receiving information from both mobile device user interface software 410 and a music/sound content package 420. The music/sound content package 420 can be downloaded from a remote device. The audio user interface control unit 400 also provides information to audio players 430 such as audio engines, a MIDI player, or other media playing devices.

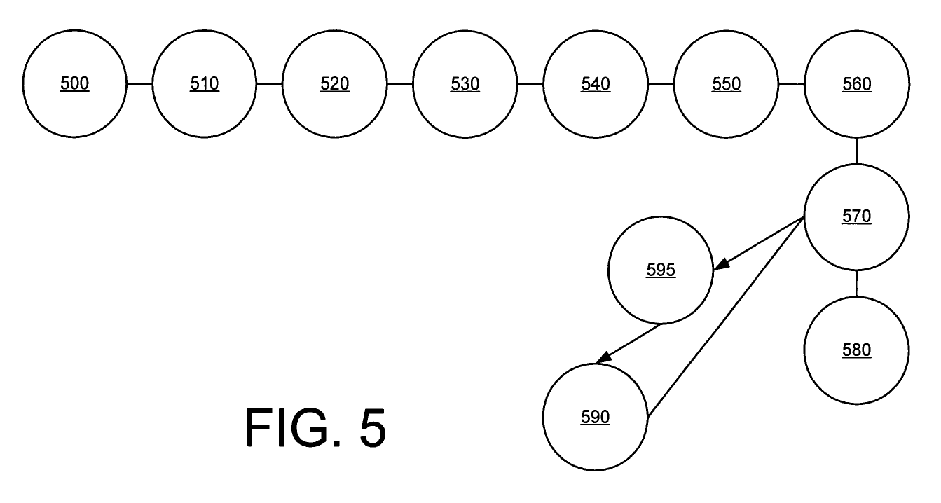

FIG. 5 is a flow chart showing one representative process for the implementation of the present invention. At step 500, a user downloads an audio user interface application to his or her mobile telephone 12 from a commercial website. The audio user interface application, which can also define default functionalities for the audio user interface, can also be preinstalled on the mobile telephone 12. The website also includes a variety of sounds that can be played in conjunction with user interface-related activities. At step 510, the user selects a number of sounds from the website. These sounds can include virtually any type of music, sounds from nature, animal sounds, etc. At step 520, the user selects his phone model from a list on the website. At step 530, the website informs the user of the situations in which the sounds can be activated on his mobile telephone. By example, these situations can include: when the user reads or writes SMS messages, when the user uses mobile electronic mail, when the user browses phone menus, and when the user uses his calendar. At step 540, the user defines the desired rules for playing the selected sounds. For example, the user could define that he wants the songs to be played randomly and to be faded smoothly in and out when activated. The user could therefore click choice boxes of email and phone menus, for example, in order to configure the settings to his mobile telephone.

At step 550, a content package containing the desired sound data is loaded to the audio user interface control unit 400 of the mobile telephone 12 to resolve rules for the playback. The audio user interface control unit 400 may also store the actual data to its memory 58 so that it can be accessed quickly. It should also be noted that the content package can be built into the mobile telephone 12 instead of having to be downloaded to mobile telephone 12 or the content may be generated on the fly. At step 560, the user interface software 410 uses an application program interface to indicate whenever a particular, predesignated action occurs. These actions can include, but are not limited to, a user entering menu, the launching of an application, a battery for the electronic device becoming full, as well as any of the other functions discussed herein and others.

At step 570, the audio user interface control unit 400 checks whether it has a pre-loaded configuration defining sounds for the action that has just occurred. If there is no such pre-loaded configuration, no sound will play. This is represented at step 580. On the other hand, if the audio user interface control unit 400 has a sound definition for the particular user interface software action, then at step 590, the audio engine or an associated MIDI player of the mobile telephone 12 plays the designated sound or sounds. As noted above, it is also possible that the sound configuration defines a play list of sounds and rules for fading the music in/out, cross-fades etc. In such a case, the audio user interface control unit 400 may need to randomly select one of the sounds, or the next sound in the play list. The audio user interface control unit 400 can also perform a fade-in for the playback sound by sending a file to the appropriate audio player 430, setting the player's volume to zero, calling the player's ‘play’ function, and performing the fade-in during a certain time. All of these functions, which are represented at step 595, depend upon the respective content configuration. It should be noted that the steps described above do not necessarily need to be implemented in the precise order discussed herein, and it is possible for several steps to be combined and possibly eliminated as necessary or desired.

In another embodiment of the invention, the network server 26 or another server can be used with the mobile telephone 12 or other electronic device. In this situation, the network server 26 can transmit the particular ambience when it learns that the anticipated action has occurred. For example, in a situation where a user has a home network including a personal computer and stereo, the network server 26 can cause a particular song to play whenever the user opens an application on his personal computer.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of playing a sound on an electronic device, comprising:
receiving information concerning the activation of an application on the electronic device; and
selecting an ambience for operation with the activated application.

2. The method of claim 1, wherein at least one element of the ambience is downloaded from a remote location.

3. The method of claim 1, wherein the ambience is generated without downloading from a remote location.

4. The method of claim 1, wherein the ambience for the activated application is played upon the occurrence of an action selected from the group consisting of a displaying of a message, an input of a message, use of electronic mail, browsing of menus on the electronic device, accessing of a calendar, accessing of contact information, launching an application, and having the level of a battery in the electronic device reach a predetermined level.

5. The method of claim 1, further comprising defining a plurality of rules concerning the manner in which the ambience is played, wherein when the ambience is played, the ambience is played according to the defined plurality of rules.

6. The method of claim 1, wherein the ambience is selected from group consisting of background music, colors, lighting, and combinations thereof.

7. A computer program product for playing a sound on an electronic device, comprising:
computer code for receiving information concerning the activation of an application on the electronic device; and
computer code for selecting an ambience for operation with the activated application.

8. The computer program product of claim 7, wherein at least one element of the ambience is downloaded from a remote location.

9. The computer program product of claim 7, wherein the ambience is generated without downloading from a remote location.

10. The computer program product of claim 7, wherein the ambience for the activated application is played upon the occurrence of an action selected from the group consisting of a displaying of a message, an input of a message, use of electronic mail, browsing of menus on the electronic device, accessing of a calendar, accessing of contact information, launching an application, and having the level of a battery in the electronic device reach a predetermined level.

11. The computer program product of claim 7, further comprising computer code for defining a plurality of rules concerning the manner in which the ambience is played, wherein when the ambience is played, the ambience is played according to the defined plurality of rules.

12. The computer program product of claim 7, wherein the ambience is selected from group consisting of background music, colors, lighting, and combinations thereof.

13. An electronic device, comprising:
a processor; and
a memory unit operatively connected to the processor, the memory unit including:
computer code for receiving information concerning the activation of an application on the electronic device; and
computer code for selecting an ambience for operation with the activated application.

14. The electronic device of claim 13, wherein at least one element of the ambience is downloaded from a remote location.

15. The electronic device of claim 13, wherein the ambience is generated without downloading from a remote location.

16. The electronic device of claim 13, wherein the ambience for the activated application is played upon the occurrence of an action selected from the group consisting of a displaying of a message, an input of a message, use of electronic mail, browsing of menus on the electronic device, accessing of a calendar, accessing of contact information, launching an application, and having the level of a battery in the electronic device reach a predetermined level.

17. The electronic device of claim 13, wherein the memory unit further includes computer code for defining a plurality of rules concerning the manner in which the ambience is played, wherein when the ambience is played, the ambience is played according to the defined plurality of rules.

18. The electronic device of claim 13, wherein the ambience is selected from group consisting of background music, colors, lighting, and combinations thereof.

19. A server for communication with an electronic device, comprising:
a processor for processing information;
a communication link operative connected to the processor for communicating with the electronic device; and
a memory unit operative connected to the processor and including:
computer code for receiving information concerning the activation of an application on the electronic device; and
computer code for, in response to the received information, selecting an ambience for operation with the activated application.

20. A system, comprising:
an electronic device; and
a server in communication with the electronic device,
wherein, upon the activation of an application on the electronic device, information concerning the activation is transmitted to the server, and wherein the server selects an ambience for operation with the activated application in response to the received information.
